(19) United States
(12) Patent Application Publication
(10) Pub. No.: US 2021/0374532 A1
(43) Pub. Date: Dec. 2, 2021

(54) LEARNING METHOD FOR A NEURAL NETWORK, COMPUTER PROGRAM IMPLEMENTING SUCH A METHOD, AND NEURAL NETWORK TRAINED BY SUCH A METHOD

(71) Applicant: BULL SAS, Les Clayes-sous-Bois (FR)

(72) Inventor: Alfred LAUGROS, Grenoble (FR)

(73) Assignee: BULL SAS, Les Clayes-sous-Bois (FR)

(21) Appl. No.: 17/331,570

(22) Filed: May 26, 2021

(30) Foreign Application Priority Data
Jun. 2, 2020 (EP) 20305576.9

(51) Int. Cl. G06N 3/08; G06K 9/62

(52) U.S. Cl. CPC G06N 3/08; G06K 9/6262

(57) ABSTRACT

The invention relates to a method (300) for supervised adversarial learning of a neural network (102), comprising at least one iteration of a learning step (304), called adversarial learning step, comprising the following operations:
supplying, to said neural network (102), an image (104), called adversarial image, containing a modification, called adversarial attack, provided to orient said neural network (102) towards a result, called target, different from an expected result, and
supplying, to said neural network (102), a first data item, called result data item, indicating the expected result for said adversarial image (104);
   characterized in that said step (304) of adversarial learning also comprises supplying, to said neural network (102), a second data item, called target data item, indicating said target to said neural network (102).

This application claims foreign priority to European Patent Application No. 20305576.9, filed 2 Jun. 2020, the specification of which is hereby incorporated herein by reference.

### BACKGROUND OF THE INVENTION

### Field Of The Invention

The present invention relates to a learning method for a neural network utilized for image processing. It also relates to a computer program configured to implement such a method, and a neural network trained by such a method.

The field of the invention is the field of neural networks utilized for image processing.

### Description Of The Related Art

Today, neural networks are widely utilized in the field of automated image processing, mainly for automated classification of the images, or for automated recognition of objects in the images. To this end, a neural network is first trained, during a learning phase, on a set of images, called learning set, then its performance is tested on a set of images, called test set: the latter may be partially or totally different from the learning set.

However, it may occur that an image provided to be processed by a neural network contains a modification, sometimes scarcely visible, called “adversarial attack”, introduced into said image intentionally with the aim of disturbing the neural network. When an adversarial attack is intended to orient the response of the neural network towards a given target, then it is called a “targeted adversarial attack”.

The robustness of a neural network against adversarial attacks is measured by comparing the performance of this neural network obtained on images that do not contain an adversarial attack, called non-adversarial images, with the performance of said neural network obtained on these same images in which an adversarial attack has been introduced beforehand, these images being called “adversarial images”.

The solution traditionally utilized to improve the robustness of a neural network to adversarial attacks is to utilize a learning set comprising images containing adversarial attacks: such learning is called “adversarial learning”. However, adversarial learning has the drawback of degrading the performance of the neural network on non-adversarial images.

A purpose of the present invention is to overcome this drawback.

Another purpose of the present invention is to propose a learning method of a neural network utilized for image processing making it possible to improve the robustness of said neural network against adversarial attacks while still avoiding, or at least limiting, degradation of the performance of said neural network on non-adversarial images.

### BRIEF SUMMARY OF THE INVENTION

The invention makes it possible to achieve at least one of these purposes by a supervised adversarial learning method for a neural network, comprising at least one iteration of a learning step, called adversarial learning step, comprising the following operations:
supplying, to said neural network, an image, called adversarial image, containing a modification, called adversarial attack, provided to orient said neural network towards a result, called target, different from an expected result, and
supplying, to said neural network, a first data item, called result data item, indicating the expected result for said adversarial image; characterized in that said step of adversarial learning also comprises supplying, to said neural network, a second data item, called target data item, indicating said target to said neural network.

Thus, the invention proposes to carry out learning of a neural network with adversarial images by supplying to the neural network, for at least one, in particular each, adversarial image,
a result data item, indicating to said neural network the desired response associated with this adversarial image, and
a target data item, indicating to said neural network the target that was utilized by the adversarial attack to modify said adversarial image.

Thus, the robustness of said neural network against adversarial attacks is improved without degrading, or at least limiting degradation of, the performance of said neural network on non-adversarial images.

In the present document, by “image” is meant a digital image or a numerical image, in particular numerical data representing an image.

By “adversarial attack” is meant a modification, sometimes scarcely visible or not visible at all for humans, introduced into an image with the intention of disturbing a neural network that processes this image. The adversarial attack inserted in an image aims to totally change the response of a neural network so that when said neural network processes said image its response is totally different and corresponds to a predetermined target. The adversarial attack is generally created by using neural network(s), and more particularly the architecture, the weights and the response of neural network(s) to particular examples of images.

By “targeted adversarial attack” is meant an adversarial attack intended to orient the response of the neural network towards a target. For example, an adversarial attack targeting “tree” is designed to make the neural network think that the image processed is a tree.

By “adversarial image” is meant an image containing an adversarial attack.

By “non-adversarial image” is meant an image not containing an adversarial attack.

By “adversarial learning” is meant learning of a neural network, utilizing a set of images comprising adversarial images and optionally non-adversarial images.

By “adversarial learning step” is meant a learning step utilizing an adversarial image.

By “non-adversarial learning step” is meant a learning step utilizing a non-adversarial image.

For at least one adversarial image, the result data item and the target data item can be stored together in one and the same data item, called adversarial label, indicated to said neural network during the step of adversarial learning utilizing said adversarial image.

In this case, supplying the result data item and the target data item is carried out simultaneously in a single operation. In fact, the result data item and the target data item are indicated to the neural network simultaneously, in a single operation, indicating to the neural network the adversarial label that comprises the two data items.

Alternatively, for at least one adversarial image, the result data item and the target data item can be stored individually. In this case, the result data item and the target data item can be indicated to the neural network simultaneously, or in turn.

The method according to the invention can also comprise at least one learning step that supplies as input of the neural network an image, called non-adversarial image, not containing an adversarial attack.

Such a learning step can be called non-adversarial learning step.

Such a learning step does not supply a target data item to the neural network since the non-adversarial image does not comprise an adversarial attack.

In particular, such a non-adversarial learning step supplies to the neural network only a result data item associated with the non-adversarial image supplied to the neural network during said learning step.

For at least one non-adversarial image, the result data item can be called non-adversarial label.

According to another aspect of the present invention, a set of images is proposed, provided to be utilized in a supervised adversarial learning method of a neural network, such as for example the method according to the invention.

The database according to the invention comprises:
at least one image, called adversarial image, containing a modification, called adversarial attack, provided to orient said neural network towards a result, called target, different from an expected result, and
for at least one, in particular each, adversarial image, a first data item, called result data item, stored in association with said adversarial image, provided to be supplied to said neural network and indicate to said neural network the expected result for said adversarial image;
   characterized in that it comprises, for at least one adversarial image, a second data item, called target data item, stored in association with said adversarial image, provided to be supplied to said neural network and indicate said target to said neural network.

The learning set according to the invention makes it possible to carry out learning of a neural network utilized for image processing, making it possible to improve the robustness of said neural network against adversarial attacks while still avoiding, or at least limiting, degradation of the performance of said neural network on non-adversarial images.

According to an embodiment, the learning set according to the invention can comprise only adversarial images.

According to another embodiment, the learning set according to the invention can comprise:
at least one image, called non-adversarial image, not containing an adversarial attack; and
for at least one, in particular each, non-adversarial image, a first data item, called result data item, stored in association with said non-adversarial image, provided to indicate to said neural network, the expected result for said non-adversarial image.

Such a set makes it possible to carry out better learning of the neural network, and to maintain a better performance on non-adversarial images during the utilization of the neural network.

Two adversarial images can comprise the same adversarial attack, i.e. the same targeted modification intended to orient the neural network towards one and the same incorrect result, or one and the same target, for each of said images.

In this case, these two adversarial images can have the same content, i.e. the same result data item, or different result data items.

Alternatively, or in addition, two adversarial images can comprise different adversarial attacks, i.e. different targeted modifications, intended to orient the neural network towards different incorrect results, or different targets.

In this case, these two adversarial images can have the same content, i.e. the same result data item, or different result data items.

According to another aspect of the present invention, there is proposed a computer program comprising instructions, which when they are executed by an electronic and/or computerized appliance, implement the learning method according to the invention.

The computer program can be coded with any type of computer language, such as for example C, C++, JAVA, Python, etc.

The computer program can be stored in a computerized or electronic device.

Alternatively, the computer program can be stored on a media that can be read by a computerized or electronic device, such as a memory card or a USB key for example. In this case, the invention also relates to the media storing said computer program.

According to another aspect of the present invention, there is proposed a neural network trained by the learning method according to the invention.

The neural network according to the invention can be any type of neural network that it is possible to utilize for image processing and that it is possible to train in a supervised manner.

In particular, the neural network can be a “feed forward” neural network, for example with a single-layer perceptron or a multi-layer perceptron, a recurrent neural network, a resonance neural network, etc.

### BRIEF DESCRIPTION OF THE DRAWINGS

Other advantages and characteristics will become apparent on examination of the detailed description of a non-limitative embodiment, and from the attached drawings in which:

FIG. 1 is a diagrammatic representation of a non-limitative embodiment example of an adversarial learning step capable of being implemented in a method according to the invention;

FIG. 2 is a diagrammatic representation of a non-limitative embodiment example of a non-adversarial learning step capable of being implemented in a method according to the invention; and

FIG. 3 is a diagrammatic representation of a non-limitative embodiment example of a method according to the invention.

### DETAILED DESCRIPTION OF THE INVENTION

It is well understood that the embodiments that will be described hereinafter are in no way limitative. Variants of the invention can in particular be envisaged comprising only a selection of characteristics described hereinafter in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the FIGURES, the elements common to several figures retain the same reference.

FIG. 1 is a diagrammatic representation of a non-limitative example of an adversarial learning step capable of being implemented in a method according to the invention.

The learning step 100, represented in FIG. 1, makes it possible to train a neural network 102 with an adversarial image 104.

The neural network 102 can be any type of neural network capable of being utilized for image processing and capable of being trained by supervised learning.

The adversarial image 104 can be any type of image. It comprises a content, which in the present example is a dog. Of course, the content can be anything else. The content of the adversarial image 104 can represent an object, or anything else, such as a colour or a shape. The content is indicated by a data item 106, called content data item, stored in association with the adversarial image 104. In the example shown, the content data item 106 indicates for example “dog” because the adversarial image 104 represents a dog.

In addition, the adversarial image 104 contains a modification 108, called adversarial attack, visible to the eye or not. This adversarial attack 108 can be a modification of any type: modification of a colour of the image, deletion of a part of the image, addition of an item of information in the image, etc. This adversarial attack 108 is intended to disturb the neural network 102 and orient the response of the neural network 102 towards a given target, which is not the expected result for this image. For example, this adversarial attack 108 is intended to orient the response of the neural network 102 towards “tree” while the content of the adversarial image 104 is a dog.

In addition, according to the invention, a data item 110, called target data item, is stored in association with the adversarial image 104 to indicate the target towards which the adversarial attack 108 is intended to orient the neural network 102. In other words, this target data item 110 makes it possible to indicate to the neural network 102 an incorrect result that the neural network should not return when it receives the adversarial image 104 as input.

The supervised adversarial learning step 100 in FIG. 1 comprises an operation 112 of supplying the adversarial image 104 as input of the neural network 102.

In addition, the supervised adversarial learning step 100 also comprises an operation 114 of supplying, to said neural network 102, the result data item, indicating the expected result for said adversarial image 104.

Finally, the supervised adversarial learning step 100 comprises an operation 116 of supplying, to said neural network 102, the target data item 110, indicating, to the neural network 102, the target of the adversarial attack utilized for modifying the image 104.

Operations 112-116 can be carried out in turn or simultaneously. In fact, the adversarial image 104, the result data item 106 and the target data item 110 can be supplied as input of the neural network 102, simultaneously, for example as input parameters.

In particular, the operations 114-116 of supplying result 106 and target 110 data items can be carried out simultaneously. In this case, according to an embodiment, the result data item 106 and the target data item 110 can be stored individually, for example respectively as result label and target label. Alternatively, the result data item 106 and the target data item 110 can be stored together, for example in a single tag, or label.

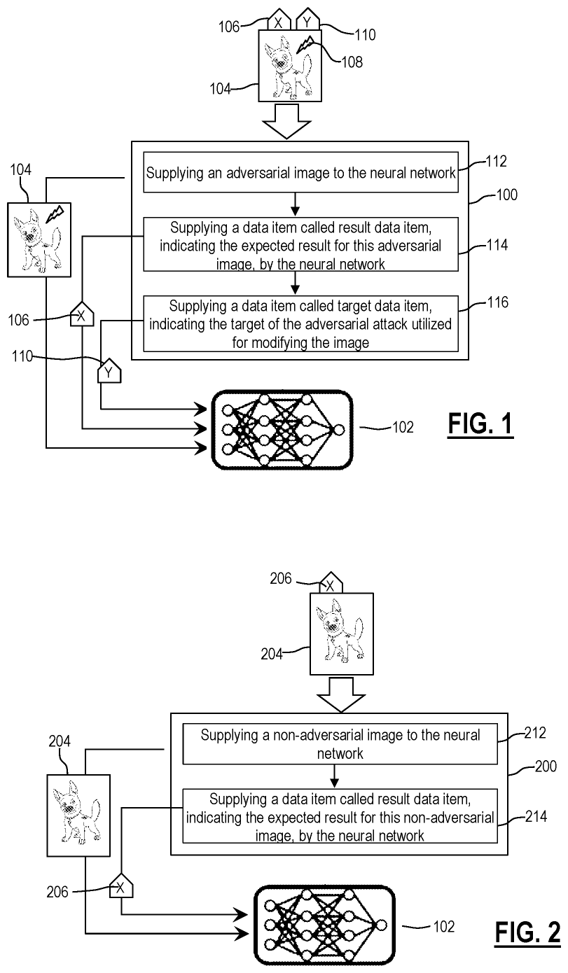

FIG. 2 is a diagrammatic representation of a non-limitative example of a non-adversarial learning step capable of being implemented in a method according to the invention.

The learning step 200, represented in FIG. 2, makes it possible to train the neural network 102 with a non-adversarial image 204.

The non-adversarial image 204 can be any type of image. It comprises a content, which in the present example is a dog. Of course, the content of the non-adversarial image 204 can represent an object, or anything else such as a colour or a shape. The content is indicated by a data item 206, called content data item, stored in association with the non-adversarial image 204. In the example shown, the content data item 206 indicates for example “dog” because the adversarial image 104 represents a dog.

In particular, in the example represented, the non-adversarial image 204 corresponds to the adversarial image 104 in FIG. 1, without the adversarial attack 108. Of course, this example is in no way limitative, and the content of the non-adversarial image can be different from the content of the adversarial image.

The supervised non-adversarial learning step 200 in FIG. 2 comprises an operation 212 of supplying the non-adversarial image 204 as input of the neural network 102.

In addition, the supervised non-adversarial learning step 200 also comprises an operation 214 of supplying, to said neural network 102, the result data item, indicating the expected result for said non-adversarial image 104.

Operations 212-214 can be carried out in turn or simultaneously. In fact, the non-adversarial image 204 and the result data item 206 can be supplied as input of the neural network 102, simultaneously, for example as input parameters.

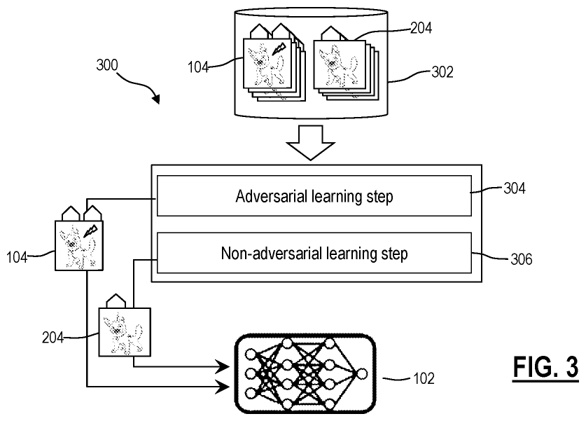

FIG. 3 is a diagrammatic representation of a non-limitative example of a learning method according to the invention.

The method 300 in FIG. 3 is utilized for training a neural network in a supervised manner, such as for example the neural network 102 in FIGS. 1 and 2.

To this end, the method utilizes a set of images 302 according to the invention comprising adversarial images, and optionally non-adversarial images.

In the example represented, the set of images 302 comprises adversarial images, such as for example the adversarial image 104 in FIG. 1, and non-adversarial images, such as for example the non-adversarial image 204 in FIG. 2.

The method 300 comprises one or more iterations of an adversarial learning step 304, each iteration being carried out with an adversarial image stored in the set of images 302.

The adversarial learning step 304 can correspond to the adversarial learning step 100 in FIG. 1.

The method 300 also comprises one or more iterations of a non-adversarial learning step 306, each iteration being carried out with a non-adversarial image stored in the set of images 302.

The non-adversarial learning step 306 can correspond to the non-adversarial learning step 200 in FIG. 2.

The iteration(s) of the adversarial learning step 304 and the iteration(s) of the non-adversarial learning step 306 can be carried out in any order, for example alternately, or in turn, etc. Alternatively, all the iterations of the adversarial learning step 304 can be carried out before the iteration(s) of the non-adversarial learning step 306.

In general terms, the iteration(s) of the adversarial learning step 304 and of the non-adversarial learning step 306 can be carried out and sequenced according to any other pattern than those indicated.

The number of iteration(s) of the adversarial learning step 304 can be identical, or different, from the number of iteration(s) of the non-adversarial learning step 306.

Of course, the invention is not limited to the examples detailed above.

In particular, the images utilized are not limited to the examples described.

According to alternatives that are not shown, the method according to the invention may not comprise a non-adversarial learning step.

According to alternatives that are not shown, the set according to the invention may not comprise a non-adversarial image.

1. A supervised adversarial learning method (300) for a neural network (102), comprising at least one iteration of an adversarial learning step (100;304), comprising:
supplying, to said neural network (102), an adversarial image (104) containing a modification (108), said modification comprising an adversarial attack, provided to orient said neural network (102) towards a result, said result comprising a target, different from an expected result, and
supplying, to said neural network (102), a first data item comprising a result data item, indicating the expected result for said adversarial image (104);
wherein said adversarial learning step further comprises supplying, to said neural network (102), a second data item comprising a target data item, indicating said target to said neural network (102).

2. The supervised adversarial learning method (300) according to claim 1, wherein for said adversarial image (104), the result data item and the target data item are stored together in one and a same data item, said same data item comprising an adversarial label, supplied to said neural network (102) during the adversarial learning step (100;304) utilizing said adversarial image (104).

3. The supervised adversarial learning method (300) according to claim 1, further comprising at least one learning step (200;306) that supplies as input of the neural network (102) non-adversarial image, wherein said non-adversarial image does not contain an adversarial attack.

4. The supervised adversarial learning method (300) according to claim 1, further comprising utilizing a set of images (302) comprising:
at least one adversarial image (104), containing a modification (108), wherein said modification comprises an adversarial attack, provided to orient said neural network (102) towards a result, wherein said result comprises a target, different from an expected result, and
for said at least one adversarial image (104), a first data item comprising a result data item, wherein said first data item is stored in association with said at least one adversarial image (104), provided to be supplied to said neural network (102) and indicate to said neural network (102) the expected result for said at least one adversarial image (104);
for said at least one adversarial image (104), a second data item comprising a target data item, wherein said second data item is stored in association with said at least one adversarial image (104), provided to be supplied to said neural network (102) and indicate said target to said neural network (102).

5. The supervised adversarial learning method (300) according to claim 4, wherein the set of images (302) further comprises: only adversarial images.

6. The supervised adversarial learning method (300) according to claim 4, wherein the set of images (302) further comprise:
at least one non-adversarial image (204), wherein said at least one non-adversarial image does not contain an adversarial attack; and
for said at least one non-adversarial image (204), a first data item, comprising a result data item, wherein said first data item is stored in association with said at least one non-adversarial image (204), and provided to indicate to said neural network (102) the expected result for said at least one non-adversarial image (204).

7. The supervised adversarial learning method (300) according to claim 4, wherein the set of images (302) further comprise: two adversarial images that comprise a same adversarial attack, or that comprise two different adversarial attacks.

8. A computer program comprising instructions, which when they are executed by an electronic and/or computerized appliance, implement a supervised adversarial learning method (300) for a neural network (102), comprising at least one iteration of an adversarial learning step (100;304), comprising:
supplying, to said neural network (102), an adversarial image (104) containing a modification (108), said modification comprising an adversarial attack, provided to orient said neural network (102) towards a result, said result comprising a target, different from an expected result, and
supplying, to said neural network (102), a first data item, said first data item comprising a result data item, indicating the expected result for said adversarial image (104);
wherein said adversarial learning step further comprises supplying, to said neural network (102), a second data item, said second data item comprising a target data item, indicating said target to said neural network (102).

9. (canceled)
